(19) United States
(12) Patent Application Publication
(10) Pub. No.: US 2017/0259512 A1
(43) Pub. Date: Sep. 14, 2017

(54) IMPROVED LAMINATE

(71) Applicant: Hexcel Holding GMBH, Pasching (AT)

(72) Inventors: Stephanie Wielaender, Pasching (AT); Johannes Moser, Pasching (AT)

(21) Appl. No.: 15/528,720

(22) PCT Filed: Nov. 27, 2015
(86) PCT No.: PCT/EP2015/077978

§ 371 Date: May 22, 2017

(30) Foreign Application Priority Data
Dec. 4, 2014 (AT) A50885/2014

(51) Int. Cl. B29C 70/22; F03D 3/06; F03D 1/06; D03D 5/00; D03D 15/00

(52) U.S. Cl. CPC B29C 70/22; D03D 5/00; D03D 15/0011; F03D 1/0675; F03D 3/062; B29K 2105/0809

(57) ABSTRACT

The use of a protection thread for the protection of a heat curable resin impregnated fibrous web. The web has weft and warp fibres, wherein the thread has a coefficient of thermal expansion within 10% of that of the heat curable resin impregnated fibres of the fibrous web, and wherein the coefficient of thermal expansion is measured using DIN 53752.

The present invention is concerned with heat curable fibrous webs and in particular heat curable webs based on glass, carbon or aramid fibre.

Heat curable webs such as resin impregnated woven or non-woven fibrous materials containing fibres or woven or non-woven materials in an uncured state and ready for curing are well known, they are sometimes known as prepregs and they find widespread use in the manufacture of articles. The fibres may be in the form of tows or fabrics and a tow generally comprises a plurality of thin fibres called filaments. The fibrous materials and resins employed in the prepregs will depend upon the properties required of the cured fibre reinforced material and also the use to which the cured laminate is to be put. The fibrous material is described herein as structural fibre. The resin may be combined with fibres or fabric in various ways. The resin may be tacked to the surface of the fibrous material. The resin may partially or completely impregnate the fibrous material. The resin may impregnate the fibrous material so as to provide a pathway to facilitate the removal of air or gas during processing of the prepreg material.

Articles are typically produced by laying up layers of the resin impregnated fibrous web in a mould or in a vacuum bag and heating and applying pressure to the laid up materials to cure the resin and to consolidate and shape the layers into the desired article. Such techniques are used in the manufacture of a range of articles such as wind turbine blades, panels for use as components in aircraft and automobiles and sporting goods such as skis. Pre-cured laminates can be provided with the prepreg, the laminates help to maintain the desired alignment of the fibres within the prepreg because of their increased rigidity. Pre-cured laminates can also be provided with dry fibrous reinforcement which is subsequently infused with a resin.

The cure cycles employed for curing prepregs and stacks of prepregs containing interlayers of webs of this invention are a balance of temperature and time taking into account the reactivity of the resin and the amount of resin and fibre employed. The same applies to the resin infusion of dry fibrous layers.

Fibrous webs containing weft and warp fibres arranged in tows can be woven or unwoven. The edge of these webs, parallel to the warp, is known as the selvedge. The selvedge is prone to wear, fibrillation and collapse. It is therefore known to provide reinforcement at these edges. The reinforcement is typically provided by means of a protective fibre that is intertwined along the edges of the fibrous web (known as a protection thread or selvedge thread) which secures the fibres of the fibrous web in place. As the selvedge thread is located on the edge of the web, it is exposed to forces, stresses and strains which differ from those of the warp fibres in the web. This can result in distortion of the web.

A relatively new type of laminate comprises weft and warp tows that are spaced to form an open structured grid. In this laminate the warp and weft tows are impregnated with a resin as the warp and weft tows are arranged and then cured online to form a rigid laminate sheet material.

When a sheet material of this nature is produced, the edges of the sheet become distorted and curve out of plane. The distorted areas need to be removed because a flat sheet product is required for use as an interlayer in moulded articles. Removal of these distorted regions results in an extra processing step and also produces significant wastage of material increasing the cost of the product.

The present invention aims to address these issues and/or to provide improvements generally.

According to the invention there is provided a use, a stack, or a web as defined in any one of the accompanying claims.

The inventors have discovered that a difference in the coefficient of thermal expansion between the selvedge thread and the resin impregnated fibres of the sheet material causes the deformation during the cure phase of the laminate sheet material production.

Polyester fibres are typically used to protect the edges of woven or non-woven glass fabrics, this is because they are tough and flexible. While such fibres have successfully protected the selvedge of conventional fabrics, when applied to the resin impregnated fibrous webs they have proved unsatisfactory when used with fibrous webs that are cured by heating. The application of heat during the cure phase causes the selvedge thread to shrink to a different extent compared to the resin impregnated warp and weft fibres. This causes internal stresses in the cured product which results in distortion.

In an embodiment, the selvedge of a heat curable resin impregnated woven or non-woven fibrous web having weft and warp fibres is protected because the selvedge comprises a material having a similar thermal shrinkage to that of the material of the fibrous web.

The coefficient of thermal expansion is measured by DIN 53752 and we have found that providing a protection or selvedge thread with a coefficient of thermal expansion that differs from the coefficient of thermal expansion of the impregnated fibrous material by 10% to 0%, or 7% to 1%, or 5% to 1.5%, or preferably 4% to 2% and/or combinations of the aforesaid ranges, that distortion during the cure phase will be significantly reduced. This in turn reduces the amount of material that needs to be removed or disposed, and optionally eliminates the need to waste any material at all. Preferably the coefficient of thermal expansion of the protection thread differs from the coefficient of thermal expansion of the impregnated fibrous webs by less than 5%, more preferably less than 2% and more preferably still, less than 1%. The lower the difference, the more distortion is reduced.

We have also found that the coefficient of thermal expansion may be by more than 1% up to a value of 20% more, preferably from 2% more up to a value of 10% more, and most preferably by more than 3% up to a value of 8% more and/or combinations of the aforesaid ranges.

A negative coefficient of thermal expansion is equivalent to a coefficient of thermal shrinkage. The aforesaid ranges may also correspond to thermal shrinkage as opposed to expansion. So in the aforesaid ranges, for example, a difference of a coefficient of thermal expansion that differs from the coefficient of thermal expansion of the impregnated fibrous material by 7% to 1% also extends to a difference of from −7% to −1% between the coefficient of thermal expansion of the selvedge thread and the coefficient of thermal expansion of the impregnated fibrous material, et cetera.

The invention is applicable to any system including a fabric that is impregnated and cured on line by heating. It is particularly useful in layers which are used as intermediary layers in lay ups of prepregs for the production of large articles such as wind turbine blades, and those where the warp and weft are arranged as an open structured grid. The invention is also not limited to a selvedge thread but to any thread applied to a resin impregnated fabric prior to curing online.

In an embodiment of the present invention the extent of shrinkage of the protection or selvedge thread is matched to that of the resin impregnated fibrous webs, when the resin impregnated fibrous webs are cured by heating at 195° C. for 3 minutes. The extent of shrinkage is the change in length of the fibre following heating, divided by the original fibre length. In particular, the thread exhibits an extent of shrinkage and/or coefficient of thermal expansion that is matched to that of the warp direction fibrous webs. Preferably the extent of shrinkage when heated at 195° C. for 3 minutes of the protection thread is within 1% of the value of the resin impregnated fibrous material of the web, more preferably within 0.2% and more preferably still within 0.1%.

In a preferred embodiment the thread comprises the same fibre material as the fibres in the resin impregnated webs. The configuration of the thread may be adapted to meet the desired thermal expansion. In a particularly preferred embodiment the protection thread is impregnated with the same resin material as the resin impregnated fibrous web. Coating may occur before or after the protection thread is applied to the fabric. The resin can influence the coefficient of thermal shrinkage during cure; therefore it is preferable that the protection thread is also coated with the same resin as the fibrous webs in order to provide a closely matched coefficient of thermal shrinkage.

As wind turbine blades increase in size, they require larger stacks of multiple layers of composite fibre and resin reinforcement. Conventionally, resin pre-impregnated fibrous reinforcement (prepreg) is laid up in a mould to form these stacks. Alternatively, dry fibre layers are laid up in a mould and these are subsequently infused with a curable resin matrix using a vacuum assisted resin transfer moulding process (VARTM).

It is known in the art that bent fibres, linear distortion, wrinkles or humps of fibres in a fibre reinforced composite material greatly degrade the mechanical properties, particularly the strength and E-modulus of the composite. Manufacturing of composites with highly aligned fibres is therefore very desirable. Particularly in VARTM lay ups containing dry fibre layers, maintaining fibre alignment during both lay-up and processing is a problem.

Cured or partly cured woven or non-woven fibre reinforced sheet material having weft and warp fibres are used as interlayers in a stack of one or more prepregs particularly if the prepreg contains unidirectional fibres. The interlayer prevents or reduces linear distortion of the prepregs relative to each other and/or misalignment of the unidirectional fibres. This invention is particularly useful in the production of such interlayers.

Laminate parts may be formed from any combination of one or more layers of prepreg and/or dry fibrous material and/or fibre reinforced sheet material.

The dry fibrous material may be infused with a resin.

In an embodiment of the invention a lay-up contains a plurality of partially or fully cured layers of a fibre reinforced sheet material together with interlayers of a material according to this invention. The use of the material of the invention being woven or non-woven material containing weft and warp fibres ensures that the alignment of the fibres within the prepregs in the stack is retained and the use of a web provided with the selvedge protecting material according to the invention further reduces the internal stresses in the cured sheet material and accordingly reduces the potential for distortion of the final moulded article.

The use of partially or fully cured fibre reinforced sheet material prepared according to this invention allows for the production of articles of very high fibre content and from large stacks of materials with highly aligned fibres in the sheets. In addition, the combination of the sheet shape with the cured state facilitates adjustment of the sheets to the shape of the mould without compromising the alignment, or in other words the straightness, of the fibres in the lay-up forming the composite member or part. This is particularly important to complex shapes such as an airfoil of wind turbine blade, where the desired fibre distribution is a complicated three-dimensional shape.

Elements of a desired shape may be cut from the material of the invention to facilitate a particular layup to form a composite member or part.

The elements of cured fibre reinforced sheet material prepared according to this invention may be provided along a shorter or a longer fraction of the length of the composite structure. However in the manufacture of wind turbine blades it is typically preferred that the elements are positioned along at least 75% of the length of the wind turbine blade shell member and in many cases it is more preferred that the cured fibre reinforced sheet material is positioned along at least 90% of the length of the composite structure.

The fibrous material in the web of the present invention may be carbon fibres, glass fibres, aramid fibres, natural fibres, such as cellulose-based fibre like wood fibres, organic fibres or other fibres, which may be used for reinforcement purposes. The protection thread is preferably a fibrous material intertwined at the end of the weft fibres and is preferably fibres of the same material as the fibres within the sheet. However other fibres may be used provided its properties match those of the fibrous web and provides a suitable protection function for the web.

The structural fibres may be made from a wide variety of materials, such as carbon, graphite, glass, metallized polymers, aramid and mixtures thereof. Glass and carbon fibres are preferred with carbon fibre being preferred for wind turbine shells of length above 40 metres such as from 50 to 60 metres. The structural fibres, may be individual tows made up of a multiplicity of individual fibres and they may be woven or non-woven fabrics. The fibres may be unidirectional, bidirectional or multidirectional according to the properties required in the final laminate. Typically the fibres will have a circular or almost circular cross-section with a diameter in the range of from 3 to 20 μm, preferably from 5 to 12 μm. Different fibres may be used in different prepregs used to produce a cured laminate.

Exemplary layers of unidirectional structural fibres are made from HexTow® carbon fibres, which are available from Hexcel Corporation. Suitable HexTow® carbon fibres for use in making unidirectional fibre layers include: IM7 carbon fibres, which are available as fibres that contain 6,000 or 12,000 filaments and weight 0.223 g/m and 0.446 g/m respectively; IM8-IM10 carbon fibres, which are available as fibres that contain 12,000 filaments and weigh from 0.446 g/m to 0.324 g/m; and AS7 carbon fibres, which are available in fibres that contain 12,000 filaments and weigh 0.800 g/m.

The thermocurable resin used in the web of the present invention may comprise an epoxy resin having an epoxy equivalent weight in the range of from 50 to 250, preferably from 100 to 200, and an amine hardener, the resin material being in-line curable.

The reactivity of an epoxy resin is indicated by its epoxy equivalent weight (EEW) the lower the EEW the higher the reactivity. The epoxy equivalent weight can be calculated as follows: (Molecular weight epoxy resin)/(Number of epoxy groups per molecule). Another way is to calculate with epoxy number that can be defined as follows: Epoxy number=100/epoxy eq. weight. To calculate epoxy groups per molecule: (Epoxy number×mol. weight)/100. To calculate mol. weight: (100×epoxy groups per molecule)/epoxy number. To calculate mol. weight: epoxy eq. weight×epoxy groups per molecule. The present invention is particularly concerned with providing a prepreg that can be based on a reactive epoxy resin that can be cured at a lower temperature with an acceptable moulding cycle time.

The epoxy resin has a high reactivity as indicated by an EEW in the range from 150 to 1500 preferably a high reactivity such as an EEW in the range of from 200 to 500 and the resin composition comprises the resin and an accelerator or curing agent. Suitable epoxy resins may comprise blends of two or more epoxy resins selected from monofunctional, difunctional, trifunctional and/or tetrafunctional epoxy resins.

Suitable difunctional epoxy resins, by way of example, include those based on: diglycidyl ether of bisphenol F, diglycidyl ether of bisphenol A (optionally brominated), phenol and cresol epoxy novolacs, glycidyl ethers of phenol-aldelyde adducts, glycidyl ethers of aliphatic diols, diglycidyl ether, diethylene glycol diglycidyl ether, aromatic epoxy resins, aliphatic polyglycidyl ethers, epoxidized olefins, brominated resins, aromatic glycidyl amines, heterocyclic glycidyl imidines and amides, glycidyl ethers, fluorinated epoxy resins, glycidyl esters or any combination thereof.

Difunctional epoxy resins may be selected from diglycidyl ether of bisphenol F, diglycidyl ether of bisphenol A, diglycidyl dihydroxy naphthalene, or any combination thereof.

Suitable trifunctional epoxy resins, by way of example, may include those based upon phenol and cresol epoxy novolacs, glycidyl ethers of phenol-aldehyde adducts, aromatic epoxy resins, aliphatic triglycidyl ethers, dialiphatic triglycidyl ethers, aliphatic polyglycidyl amines, heterocyclic glycidyl imidines and amides, glycidyl ethers, fluorinated epoxy resins, or any combination thereof. Suitable trifunctional epoxy resins are available from Huntsman Advanced Materials (Monthey, Switzerland) under the tradenames MY0500 and MY0510 (triglycidyl para-aminophenol) and MY0600 and MY0610 (triglycidyl meta-aminophenol). Triglycidyl meta-aminophenol is also available from Sumitomo Chemical Co. (Osaka, Japan) under the tradename ELM-120.

Suitable tetrafunctional epoxy resins include N,N,N′,N′-tetraglycidyl-m-xylenediamine (available commercially from Mitsubishi Gas Chemical Company under the name Tetrad-X, and as Erisys GA-240 from CVC Chemicals), and N,N,N′,N′-tetraglycidylmethylenedianiline (e.g. MY0720 and MY0721 from Huntsman Advanced Materials). Other suitable multifunctional epoxy resins include DEN438 (from Dow Chemicals, Midland, Mich.) DEN439 (from Dow Chemicals), Araldite ECN 1273 (from Huntsman Advanced Materials), and Araldite ECN 1299 (from Huntsman Advanced Materials).

The cured fibre reinforced web of this invention is a relatively flat member having a length, which is at least ten times the width, and a width, which is at least 5 times the thickness of the sheet material. Typically, the length is 20-50 times the width or more and the width is 20 to 100 times the thickness or more. In a preferred embodiment, the shape of the sheet material is band-like.

The width of the cured fibre reinforced sheet material typically varies along the length of the sheet material. Typically, the maximum width should be more than 100 mm and to reduce the number of sheets, a width of more than 150 mm is desirable. Experimental work has shown that in many cases, the width may preferably be more than 200 mm at the widest place. On the other hand, the resin must travel between adjacent sheets in length corresponding to the width of the sheet and hence the maximum width of the sheet material is preferably less than 500 mm to allow for suitable control of resin introduction. In a preferred embodiment, the maximum width is less than 400 mm and for example if the resin is selected so that it initiates curing prior to complete infusion, it is preferred that the maximum sheet width is less than about 300 mm.

The selvedge protection material is selected according to the nature of the fibre in the web. Examples of suitable materials include glass, carbon fibre, glass fibre or aramid fibre.

From an economic point of view it is desirable that the cycle time of laminate parts be as short as possible. For laminate parts containing thermosetting resins, as well as requiring heat to initiate curing of the resin the curing reaction itself can be highly exothermic and this needs to be taken into account in the time/temperature curing cycle in particular for the curing of large and thick stacks of prepregs as is increasingly the case with the production of laminates for industrial application where large amounts of resin are employed and high temperatures can be generated within the stack due to the exotherm of the resin curing reaction. Excessive temperatures are to be avoided as they can damage the mould reinforcement or cause some decomposition of the resin. Excessive temperatures can also cause loss of control over the cure of the resin leading to run away cure.

Generation of excessive temperatures can be a greater problem when thick sections comprising many layers are to be cured as is becoming more prevalent in the production of fibre reinforced laminates for heavy industrial use such as in the production of wind turbine structures particularly wind turbine spars and shells from which the blades are assembled. In order to compensate for the heat generated during curing it has been necessary to employ a dwell time during the curing cycle in which the moulding is held at a constant temperature for a period of time to control the temperature of the moulding and is cooled to prevent overheating this increases cycle time to undesirably long cycle times of several hours in some instances more than eight hours.

For example a thick stack of epoxy based fibrous layers such as 60 or more layers can require cure temperatures above 100° C. for several hours. However, the cure can have a reaction enthalpy of 150 Joules per gram of resin or more and this reaction enthalpy brings the need for a dwell time during the cure cycle at below 90° C. to avoid overheating and decomposition of the resin. Furthermore, following the dwell time it may be necessary to heat the stack further to above 90° C. (for example to above 100° C.) to complete the cure of the resin. This leads to undesirably long and uneconomic cure cycles. In addition, the high temperatures generated can cause damage to the mould or bag materials or require the use of special and costly materials for the moulds or bags.

In addition to these problems there is a desire to produce laminar structures in which the cured resin has a high glass transition temperatures (Tg) such as above 65° C. to extend the usefulness of the structures by improving their resistance to exposure at high temperatures and/or high humidity for extended periods of time which can cause an undesirable lowering of the Tg. For wind energy structures a Tg above 70° C. is preferred. Increase in the Tg may be achieved by using a more reactive resin. However the higher the reactivity of the resin the greater the heat released during curing of the resin in the presence of hardeners and accelerators which increases the attendant problems as previously described.

The prepregs used in this invention preferably comprise a resin system comprising an epoxy resin containing from 20% to 85% by weight of an epoxy of EEW from 150 to 1500, and 0.5 to 10 wt % of a curing agent, the resin system comprising an onset temperature in the range of from 115 to 125° C., and/or a peak temperature in the range of from 140 to 150° C., and/or an enthalpy in the range of from 80 to 120 J/g (Tonset, Tpeak, Enthalpy measured by DSC (=differential scanning calorimetry) in accordance with ISO 11357, over temperatures of from −40 to 270° C. at 10° C./min). Tonset is defined as the onset-temperature at which curing of the resin occurs during the DSC scan, whilst Tpeak is defined as the peak temperature during curing of the resin during the scan.

The structural fibres employed in lay-up both in the prepregs and as dry fibre reinforcement may be in the form of random, knitted, non-woven, multi-axial or any other suitable pattern. For structural applications, it is generally preferred that the fibres be unidirectional in orientation. When unidirectional fibre layers are used, the orientation of the fibre can vary throughout the prepreg stack. However, this is only one of many possible orientations for stacks of unidirectional fibre layers. For example, unidirectional fibres in neighbouring layers may be arranged orthogonal to each other in a so-called 0/90 arrangement, which signifies the angles between neighbouring fibre layers. Other arrangements, such as 0/+45/−45/90 are of course possible, among many other arrangements.

The sheet material may have the following properties [(refers to measurement standard)]:

| Fibre volume fraction (%) | 57 to 60; |
|---|---|
| Tensile strength(ISO527-5) (MPa) | 1600 to 2000; |
| Tensile modulus (ISO527-5) (GPa) | 120 to 150; |
| Tensile elongation (ISO527-5) (%) | 1.20 to 1.33 |
| Flexural strength (ISO527-5) (MPa) | 2100 to 2200; |
| Flexural modulus (EN2562) (GPa) | 120 to 150; |
| Interlaminar shear strength (EN2563) (MPa) | 90 to 100; |
| Compression strength (ASTM D6641) (MPa) | 1200 to 1300; |
| Compression modulus (ASTM D6641) (GPa) | 120 to 130; |
| Elongation (ASTM D6641) (%) | 0.99 |

The fibre volume fraction is the volume of the sheet material that is occupied by the fibres. The sheet may have an areal weight in the range of from 1500 to 4000 g/m², preferably from 2000 to 2800 g/m², more preferably 2200 g/m². The Tg of the resin matrix may be from 100 to 150° C., preferably 110 to 140° C., more preferably 110 to 130° C.

As discussed the sheet material of the invention can be interspersed at selected intervals within the stack of prepregs or dry reinforcement or combinations of one or more layers of prepreg, dry reinforcement and/or reinforced sheet materials.

Curing at a pressure close to atmospheric pressure can be achieved by the so-called vacuum bag technique. This involves placing the lay-up stack in an air-tight bag and creating a vacuum on the inside of the bag. The bag may be placed in or over a mould prior or after creating the vacuum.

If infused, the infusion resin is supplied to the dry fibre layers by suitable conduits. The infusion resin or second infusion resin is drawn through the dry fibres by the reduced pressure inside the bag.

The resins are then cured by externally applied heat to produce the moulded laminate or part. The use of the vacuum bag has the effect that the stack experiences a consolidation pressure of up to atmospheric pressure, depending on the degree of vacuum applied.

Upon curing, the stack becomes a composite laminate, suitable for use in a structural application, such as for example an automotive, marine vehicle or an aerospace structure or a wind turbine structure such as a shell for a blade or a spar. Such composite laminates can comprise structural fibres at a level of from 80% to 15% by volume, preferably from 58% to 65% by volume.

The invention has applicability in the production of a wide variety of materials. One particular use is in the production of wind turbine blades. Typical wind turbine blades comprise two long shells which come together to form the outer surface of the blade and a supporting spar within the blade and which extends at least partially along the length of the blade. The shells and the spar may be produced by curing the prepreg/dry fibre stacks of the present invention.

The length and shape of the shells vary but the trend is to use longer blades (requiring longer shells) which in turn can require thicker shells and a special sequence of materials within the stack to be cured. This imposes special requirements on the materials from which they are prepared. Carbon fibre based prepregs are preferred for blades of length 30 metres or more particularly those of length 40 metres or more such as 45 to 65 metres whilst the dry fibre is preferably a glass fibre. The length and shape of the shells may also lead to the use of different prepregs/dry fibre materials within the stack from which the shells are produced and may also lead to the use of different prepregs/dry fibre combinations along the length of the shell.

During vacuum assisted processing and curing, it may be very difficult to introduce resin between sheets of dry fibre material if the sheets are positioned very close. This is particularly the case if the space between the sheets is also subjected to vacuum.

In a preferred embodiment of the invention, the prepreg and/or the cured fibre-reinforced sheet material is provided with a surface texture to facilitate introduction of resin between adjacent elements of prepreg and/or cured fibre-reinforced sheet material. The surface texture may comprise resin protrusions of a height above a main surface of the cured fibre-reinforced sheet material, preferably in the order of about 0.1 mm to 0.5 mm, preferably from 0.5 to 3 mm, but larger protrusions may in some cases, such as when the resin introduction distance is relatively large, be larger. The resin protrusions may be uncured, cured or partially cured.

The surface texture may in addition to this or as an alternative comprise recesses, such as channels into the main surface of the cured fibre-reinforced sheet material, preferably the recesses are in the order of 0.1 mm to 0.5 mm below the main surface, but in some cases larger recesses may be suitable. Typically, the protrusions and/or recesses are separated by 1 cm to 2 cm and/or by 0.5 to 4 cm, but the spacing may be wider or smaller dependent on the actual size of the corresponding protrusions and/or recesses.

In a preferred embodiment, the facilitating effect of surface texture on the resin distribution during resin introduction is realized by providing a plurality of inner spacer elements between adjacent elements of the cured fibre-reinforced sheet material. The inner spacer elements may advantageously be selected from one or more members of the group consisting of a collection of fibres, such as glass fibres and/or carbon fibres, a solid material, such as sand particles, and a high melting point polymer, e.g. as dots or lines of resin. It is preferred that the inner spacer elements are inert during the resin introduction, and for example does not change shape or react with the introduced resin. Using inner spacer elements may be advantageous in many cases, as it does not require any particular method of manufacturing of the cured fibre-reinforced sheet material or a special pre-treatment of the cured fibre-reinforced sheet material. The inner spacing elements are preferably in the size range of 0.1 mm to 0.5 mm and separated by typically 1 cm to 2 cm, but both the sizes and the spaces may be suitable in some cases. Typically, the larger the inner spacing element, the larger the spacing can be allowed.

Alternatively, one or more suitable spacers may be used to space the dry fibre material layers. A suitable space may comprise silicon paper. This may layer be removed following processing and curing of the stack.

As discussed, to facilitate the introduction of resin this process may advantageously be vacuum assisted. The method may comprise the step of forming a vacuum enclosure around the composite structure. The vacuum enclosure may preferably be formed by providing a flexible second mould part in vacuum tight communication with the mould. Thereafter a vacuum may be provided in the vacuum enclosure by a vacuum means, such as a pump in communication with the vacuum enclosure so that the resin may be introduced by a vacuum assisted process, such as vacuum assisted resin transfer moulding, VARTM. A vacuum assisted process is particularly suitable for large structures, such as wind turbine blade shell members, as long resin transportation distances could otherwise lead to premature curing of the resin, which could prevent further infusion of resin. Furthermore, a vacuum assisted process will reduce the amount of air in the wind turbine blade shell member and hence reduce the presence of air in the infused composite, which increases the strength and the reproducibility.

The infusion resin may be curable at temperatures of from 60 to 100° C., preferably from 60 to 90° C., more preferably from 80 to 100° C. The resin may have a viscosity during the infusion phase of from 50 to 200 mPas, preferably from 100 to 160 mPas and more preferably of from 120 to 150 mPas. The neat infusion resin may have a density ranging of from 1.1 to 1.20 g/cm³; a flexural strength of from 60 to 150 N/mm², preferably from 90 to 140 N/mm²; an elasticity modulus of from 2.5 to 3.3 kN/mm², preferably from 2.8 to 3.2 kN/mm²; a tensile strength of from 60 to 80 N/mm², preferably from 70 to 80 N/mm²; a compressive strength of from 50 to 100 N/mm²; elongation at break of from 4 to 20%, preferably from 8 to 16% and/or combinations of the aforesaid properties.

A suitable infusion resin may be Epikote MGS RIM 135 as supplied by Hexion. Composite parts or members according to the invention or manufactured by the method according to the invention may either form a wind turbine blade shell individually or form a wind turbine blade shell when connected to one or more further such composite members, e.g. by mechanical fastening means and/or be adhesive. From such wind turbine blade shells, a wind turbine blade may advantageously be manufactured by connecting two such wind turbine blade shells by adhesive and/or mechanical means, such as by fasteners. Both the wind turbine blade shell and the combined wind turbine blade may optionally comprise further elements, such as controlling elements, lightning conductors, etc. In a particularly preferred embodiment, each blade shell consists of a composite member manufacturable by the method according to the invention. In another preferred embodiment, the wind turbine blade shell member manufactured by the method according to the invention forms substantially the complete outer shell of a wind turbine blade, i.e. a pressure side and a suction side which are formed integrally during manufacturing of the wind turbine blade shell member.

One aspect of the invention concerns a wind turbine blade comprising one or more webs according to this invention, prepreg, resin infused dry fibre material and cured fibre-reinforced sheet material. The cured fibre-reinforced sheet material is may be positioned near the outer surface of the blade as partially overlapping tiles.

In a preferred embodiment the cured fibre-reinforced sheet material is pultruded or band pressed cured fibre-reinforced sheet material and has been divided into elements of cured fibre-reinforced sheet material. In another preferred embodiment, a wind turbine blade according to the invention has a length of at least 40 m. The ratio of thickness, t, to chord, C, (t/C) is substantially constant for airfoil sections in the range between 75%<r/R<95%, where r is the distance from the blade root and R is the total length of the blade. Preferably the constant thickness to chord is realized in the range of 70%<r/R<95%, and more preferably for the range of 66%<r/R<95%.

This may be realised for a wind turbine blade according to the invention due to the very dense packing of the fibres in areas of the cross section of the blade, which areas provide a high moment of inertia. Therefore, it is possible according to the invention to achieve the same moment of inertia with less reinforcement material and/or to achieve the same moment of inertia with a more slim profile. This is desirable to save material and to allow for an airfoil design according to aerodynamic requirements rather than according to structural requirement.

1. (canceled)

2. (canceled)

3. (canceled)

4. (canceled)

5. A resin impregnated fibrous web having warp and weft fibres and a selvedge wherein the resin is thermocurable and the selvedge is protected by a selvedge thread having a coefficient of thermal expansion within 10% of that of the resin impregnated fibres of the fibrous web, the coefficient of thermal expansion being measured using DIN 53752.

6. A resin impregnated fibrous web according to claim 5 in which the fibrous web is based on glass fibre, carbon fibre or aramid fibre.

7. A resin impregnated fibrous web according to claim 5 in which the selvedge thread comprises fibres of the same material as the fibrous web.

8. A resin impregnated fibrous web according to claim 5 in which the selvedge thread is impregnated with a resin.

9. (canceled)

10. (canceled)

11. (canceled)

12. A stack comprising a plurality of prepregs and containing at least one interlayer comprising a resin impregnated fibrous web according to claim 5.

13. A wind turbine blade obtained by heat curing a stack according to claim 12.
